(19) United States
(12) Patent Application Publication
(10) Pub. No.: US 2017/0340956 A1
(43) Pub. Date: Nov. 30, 2017

(54) METHOD FOR MONITORING QUEST PROGRESS

(71) Applicant: Quest Giver, LLC, Manchester, NH (US)

(72) Inventor: Jonathan Roberts, Canaan, NH (US)

(21) Appl. No.: 15/165,497

(22) Filed: May 26, 2016

(51) Int. Cl. A63F 13/20; A63F 13/63; A63F 13/69; A63F 13/92

(52) U.S. Cl. CPC A63F 13/20; A63F 13/92; A63F 13/63; A63F 13/69

(57) ABSTRACT

The present invention includes a method including the steps of: providing a quest application; receiving user personal information; providing the user with a quest; informing the user criteria for the quest; receiving validation input that the criteria has been met; and determining that the provided validation input provides evidence that the criteria has been met.

### FIELD OF THE INVENTION

The present invention relates generally to online games, and more particularly, to a system and method for providing a hybrid online/real world interactive game.

### BACKGROUND

Online games and gaming are an increasingly popular leisure activity. So popular, in fact, that there is a worry that people may become stuck in the virtual reality the games provide. Combined with the fact that delivery services make it almost unnecessary to ever leave one's home, people are becoming sedentary and isolated. Therefore there is a need for a game that uses the internet and modern technology, but also encourages people to leave their homes and engage in activities.

Many online games allow users to directly compete with each other and this competition provides and enhanced level of enjoyment for many players. Further, some such games offer prizes or other rewards to players for their performance, providing additional incentive to participate. In a pure online environment, it is extremely difficult, if not impossible, for a player to cheat and relatively simple to determine who has won a particular competition. For example, in multiplayer games with direct player to player competition, there is an immediate recognition of a winner at the conclusion of a particular game. In single player games, the gaming system can easily determine who reached a certain game level, attained a high score, etc. However, in games that include an offline component, there is no built in mechanism to prevent players from cheating or for determining who won a particular game. Accordingly, in order for a game having an offline component to effectively allow for a fair competition between players, there is a need for a way to validate the player's performance and prevent cheating.

Therefore, there is a need for a game that uses the internet and modern technology, but also encourages people to leave their homes and engage in offline activities, that allows for competition between players, and that validates a player's performance to prevent cheating and allows for a fair competition.

### SUMMARY OF THE INVENTION

The present invention is a method for monitoring quest progress.

The method operates through a quest application. The quest application may be a website that requires user login credentials or a downloadable application for a mobile device or both. In some cases, the mobile device is a dedicated device whose only purpose is the quest application. A user may access his account with the quest application through the website or the mobile device application and have the account synched no matter the device on which it is accessed.

The quest application provides the user with quests to be monitored and completed through the quest application. A quest is at least one activity that consists of at least one milestone, each of which includes measurable criteria for completion. By way of example, a quest may be a single activity like, go to the library. This quest has a single action of going to the library; a single milestone, which is also its completion, of going to the library; and a measurable criteria of being in the location of the library. A more complicated quest might be to go to the mall; buy a dress that is at least 20% off; and dance on a bar by midnight. This quest would include the activities of going to the mall; buying the dress; and dancing on the bar. The criterion for the first activity is being in the location of the mall. The criterion for the second activity might be a picture of a receipt for a dress showing the discount. The criterion for the third activity is being at a bar, a photograph of the user dancing on the bar, and a time stamp of 12 A.M. or earlier. When photographs are used as evidence of completion of a milestone or quest, the photograph will be of a relevant object, such as a person, thing, place, writing, etc., a screen capture photograph of a third party application on the player's smart phone, or a photograph of a display of an third party application running on an external device, such as a step counter, GPS, speedometer, or the like.

Quests may be generated by the quest application. They may be created or suggested by users of the quest application. They may be sponsored by outside third parties that use the quest application to generate interest in an event, such as a 5K race for charity or a pie eating competition.

Quests may be performed by individuals or by groups. Groups may be created within the quest application in several ways. The quest application may create groups based on information provided by the user and saved as a user profile within the quest application. Every user will provide at least a “home base,” which is likely the user's home or office, but is the most likely location a user will perform quests that may be performed in situ or from which a user will commence or set out to perform quests. The quest application may create groups based on proximity of users' home bases. The users have the option to provide other information, such as age, sex, and interests. The quest application may, therefore, also create groups based on this information, such as a group for men between age 30 and 40 or people who are interested in bird watching. Users may create their own groups. They may do so by inviting other users to join a group or by inviting non-user third parties to use the quest application and then join the group. They may also do so by dictating criteria for the group to the quest application and then allowing the quest application to select users that match these criteria and invite them to the group.

Once a group is established, group quests may be performed. This may involve all group members or a certain percentage of the group members performing a specific activity, such as running a 5K in under 30 minutes. It may also be patterned like a relay race, where, for example, one group member or a set of group members must perform one activity, and upon completion of that activity, another group member or set of group members must perform another activity. For example, five group members may be tasked with picking five pumpkins; then five other group members may be tasked with gutting those five pumpkins; then five other group members may be tasked with carving those five pumpkin shells into jack-o-lanterns; while another five group members are tasked with turning the pumpkin guts into pumpkin pie. The verification of the completion of the quest would be a photograph of five jack-o-lanterns and five pumpkin pies. A group quest may also be a general goal of the group that may be achieved however the group members think best. For example, the quest may be to retrieve a hat from the top of a 20 foot tall pole. The group could complete this quest in any number of ways. They could, for example, create a human ladder or pyramid; use a real ladder; try to throw things at the hat to knock it off; spray it with a hose; climb the pole; etc. The ultimate verification of the completion of the task would be a photograph of the pole with no hat on it and the hat in the hands of a group member.

The quest application also provides a means to verify that a quest has been completed. The completion of some quests may be verified directly from the device on which the quest application has been accessed. If the quest is for example, check your credit score online, provided that necessary permissions are granted, if the device on which the user checks his credit score online is the same as the device on which he accesses the quest application, then the verification may come directly from the device. For other quests, verification directly from the device may not be possible, but for all quests, some sort of verification must be submittable to the quest application. Using the examples above, for the quest of going to the library, the user would go to the library, access the quest application, and request that the quest application detect the location of that access. This will most likely be on a mobile device. The user's request for the quest application to detect the location of that access will use the mobile device's GPS capabilities to determine the location of the mobile device. In this way, the user's completion of the quest is verified through the quest application. With the other quest example above, the first milestone in the quest is going to the mall and verification of completion of that milestone may be made as described above. The second milestone is buying a dress for at least 20% off. Verification of completion of this milestone will require photographic evidence of the dress, the purchase, and the discount. Again, such evidence may be procured by taking the photos on a mobile device and submitting those photos through the quest application. The third and ultimate milestone is dancing on a bar by midnight. Verification of completion of this milestone will include a location stamp, as described above, a photograph of the dancing on the bar, and a time stamp, which may also be provided by the mobile device through the quest application. With group quests, verification of completion of a milestone by one group member may be provided through the quest application by another group member, using the honor system. Verification of some quests may require some verification both before the commencement of and after the completion of a quest. For example, if the quest is to complete a crossword puzzle in 10 minutes or less, verification may require a photograph of the blank crossword puzzle and a starting time stamp, as well as a photograph of the completed crossword puzzle and an ending time stamp.

Most quests will be designed to follow the template or mantra of “Travel, Trials, and Triumph!” This means that most quests will have at least two milestones—one involving travel and one involving an activity or trial to be performed at the location to which the user traveled. Expanding on the library example, the overall quest might be to check a book out of library. The travel milestone, therefore, would be to get to the library. The trial milestone would be to check out a book. Upon completing these two tasks, the user is triumphant at having completed the quest. Given the travel element that most quests will include, GPS data is especially important for verifying the completion of the travel milestone. In particular, comparison GPS data between the user's home base and the location of the trial portion of the quest is important for this purpose.

The quest application may also provide recognition of milestones and/or quests completed. The quest application may, for example, designate that completion of a certain quest will give the user a certain number of points. The points may be broken down by milestone in quests that include more than one milestone. In the dancing on the bar example, some points may be awarded for going to the mall and buying the discounted dress, even if the final milestone of dancing on the bar never occurs. Bonus points may be provided for final completion of a quest or for performing particularly well. For example, if the quest is to run a 5K in under 30 minutes and the user completes the quest in 25 minutes, the user may receive bonus points for performing the quest so well. Bonus points may also be awarded in group quests. For example, if only 80% of group members are required to perform a certain milestone and 100% of them perform it, a bonus for each group member may be awarded. Point and bonus values and criteria may be established as part of the criteria associated with the quest. Recognition for quest completion may come in other forms or additional forms from points as well. Users may earn badges for quest completions, for example. Bonus points may be awarded if a user achieves all of a set of badges for a set of quests, for example. In addition, within groups, a leaderboard may list and rank the users within the group with the most points or badges. Users who have accrued a certain amount of recognition for quests completions, such as a certain number of points, badges, or other quest completion recognition, may redeem the recognition for vouchers. The vouchers may afford the user new or extra privileges within the quest application, such as being able to create a quest for a group; create a group; or name a group. Alternatively, the vouchers may be redeemed in a real world setting. Vouchers may be unrelated to the completed quests that earned the user the recognition that was redeemed for the vouchers. The user may have completed a variety of quests to earn enough points for a voucher for 10% off a local restaurant, for example. Vouchers may also be tied into the nature of the quest itself. The user may have earned ten badges for completing ten quests all related to mountain climbing and upon completion of all ten, her bonus is a $20 gift certificate to an outdoors store. One of at least ordinary skill in the art will recognize that there are many ways in which recognition for a user's completion of quests and use of the quest application may be provided through the quest application. Each of these ways is considered a part of the present invention.

The quest application therefore has many functions. It stores information about users. This information includes at least the user's home base and may include additional information, such as, age, sex, interests, etc. It provides users with quests. The user may decide how the quests are presented. The quest application may present a daily quest, for example. The quest application may only passively present quests, by allowing the user to browse through available quests and choose therefrom. The quest application may provide group members with a quest created by a user within the group. It allows for the creation of groups of users. It provides the necessary information about the quest, including the activity or activities involved in the quest; the milestone(s) associated with those activities; and the criterion for completing those milestones, including the criteria for completing the ultimate milestone, which completes the quest. The quest allocates and displays awards for milestone and quest completion, such as badges, points, vouchers, and leaderboards. The quest application may provide auto-notifications, such as when a new quest becomes available or when users complete milestones in a group quest.

Most importantly, the quest application allows for validation of the quest and milestone completion. Without this technological aspect of the invention, people would be able to cheat the system. The present invention addresses the challenge of monitoring and validating the completion of milestones and quests that will often be complete unrelated to and outside of a computer system, i.e. in the real world. As discussed above, the validation may be through GPS stamping and comparing to a user's home base, time stamping, possibly before and after a quest, and photographic evidence. Other validation may be through connection with other technologies, including monitoring technologies, such as pedometers, heart rate monitors, or even blood glucose monitors, depending on the quest. The quest application receives the validation input that the criteria have been met. It performs the analysis and comparison of the validation input versus the criteria and it determines if the relevant milestone or quest has been completed. Alternatively, the quest application may validate the date from these technologies though a screen capture photograph of the display of third party application running on the player's smart phone, or photographs of the native display of a third party application running on an external device, and not through a direct application interface.

The quest application is housed, maintained, and downloadable from a server, which includes memory and a processor. The quest application may be presented on a webpage or may be downloaded onto a device, such as a mobile phone or tablet. The quest application may also be used and presented on a dedicated device for the quest application.

Therefore it is an aspect of the present invention to provide a quest application that provides to users quests, including activities, milestones, and criteria for completing the milestones.

It is a further aspect for the quest application to allow for the formation of groups of users.

It is a further aspect for the quest application to record and allocate recognition of quest and milestone completion, such as with points, badges, vouchers, and leaderboards. It is a further aspect for the quest application to receive validation of the completion of quests and milestones through the submission of, for example, GPS stamps, time stamps, and photographic evidence.

It is a further aspect for the quest application to compare validation input with quest and milestone criteria to determine if the quest or milestone has been achieved.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a diagram of the system of the present invention.

FIG. 2 is a flow chart of the basic method of the present invention. FIG. 3 is an exemplary user interface for a quest.

FIG. 4 is a block diagram indicating additional steps of the method of the present invention.

### DETAILED DESCRIPTION

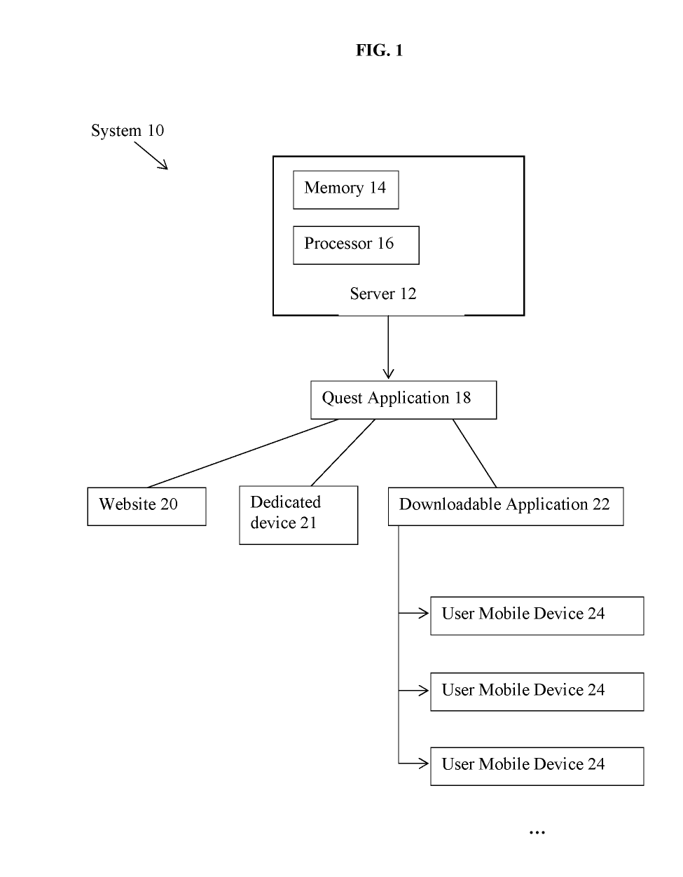

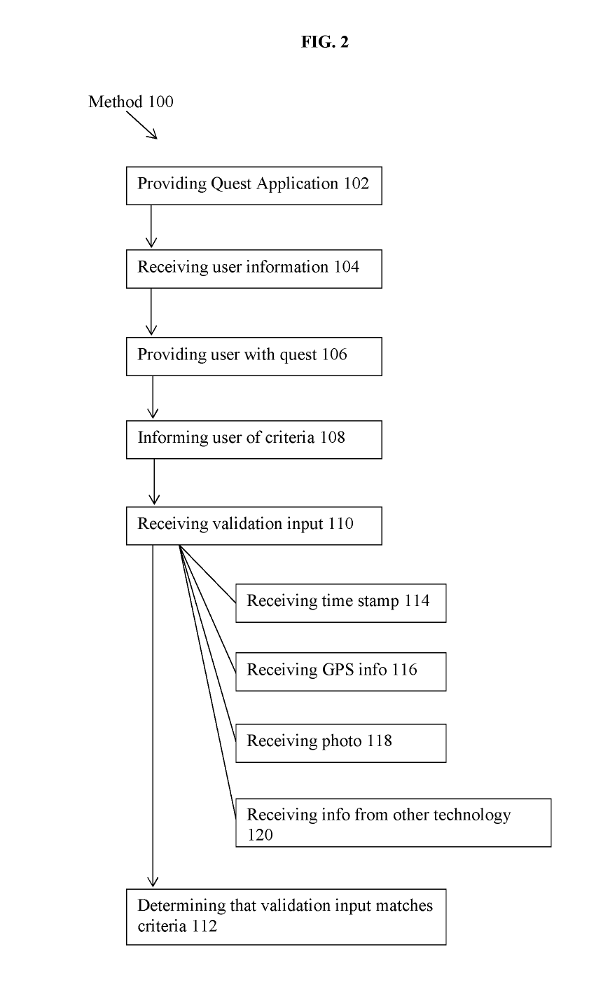

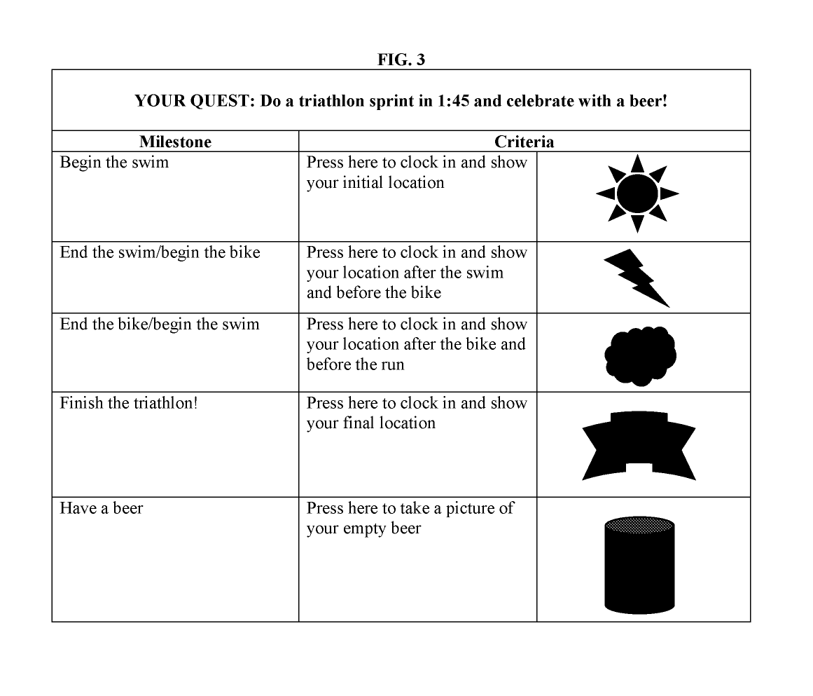

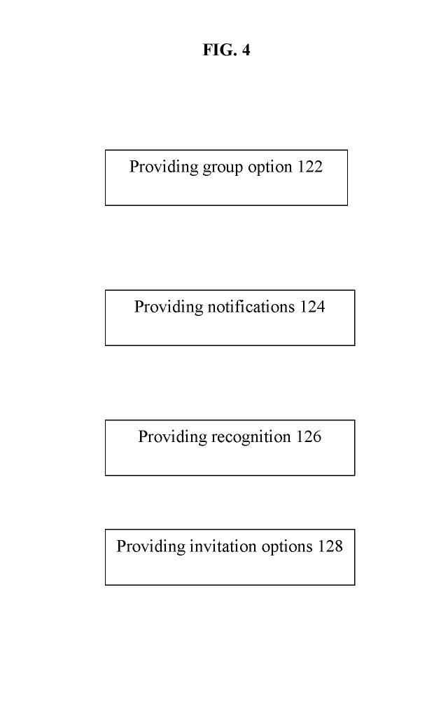

Referring first to FIG. 1, a diagram of system 10 of the present invention is provided. Quest application 18 is launched and maintained on server 12. Server 12 includes memory 14, which stores user information, quests, the activities, milestones, and criteria associated with quests, etc. Server 12 also includes processor 16, which performs the functions of quest application 18, as described in more detail with reference to FIGS. 2 and 4. Quest application 18 is accessible to users through a website 20 with login credentials, through a dedicated device 21, or as a downloadable app 22, which may be downloaded from server 12 to user devices 24. Information regarding a user's account is synched so that the same information appears whether the user accesses the quest application 18 via the website 20, the dedicated device 21, or the user device 24 using the downloadable app 22.

Now referring to FIG. 2, a flow chart of method 100 of the present invention is provided. In its most basic form, method 100 includes the steps of providing the quest application 102; receiving user information 104; providing the user with quests 106; informing the user of quest criteria 108; receiving validation input 110; and determining that that the validation input matches the criteria 112. The step of receiving validation input 110 is performed through quest application 18 and may include receiving time stamps 114; receiving GPS/location information 116; receiving photograph(s) 118; and/or receiving input from other technology or devices 120.

The first step of providing the quest application 102 is achieved by a user accessing quest application 18 via website 20, downloading it to her user device 24, and/or using a dedicated device 21. On first accessing the quest application 18, the user will create or receive login credentials. If the user downloads the quest application 18, she will likely be required to accept certain permissions, such as allowing the quest application 18 to access the GPS, timekeeping, and camera capabilities of the user device 24. This will be important for the fifth step of receiving validation input 110, as discussed below. If the quest application 18 is a dedicated device 21, then these permissions will not be necessary, as all the necessary or most commonly needed capabilities, such as GPS, timekeeping, and camera, will be included in the dedicated device 21 and incorporated into the quest application 18.

Simultaneously with the first step 102, the user will affect the second step of providing user information 104. The user information will include at least her “home base,” which is a location of her choosing, but most likely her home, work, or another place where she spends a great deal of time. Her home base is the location where she will likely perform quests that only require a computer or the location from which she will set out to perform quests that take her outside of her home. The user preferably also includes other information about herself, such as her age, sex, interests, and how far she is willing to go away from her home base to perform a quest. She may also input information, such as notification preferences, and information for communication outside of the quest application 18, such as phone number and/or email address. The user may also provide additional information after her initial use of the quest application 18.

The third step is providing the user with a quest 106. This step is performed through the quest application 18, and may occur through several different circumstances. The quest application 18 may select quests to present to the user based on the information she provided in step 104. If she only provided a home base, these quests will likely be quests that may be performed in the general vicinity of the home base. If she provided other information, the quests may have different focuses. If the user indicated that she was interested in mountain climbing, for example, the quest might be to get to the top of a particular mountain in a certain amount of time. A user may also input quests into the quest application by providing information about the quest, including the activity or activities it involves, the milestone or milestones that must be reached, and the criteria for achieving those milestone(s). That quest may then be pushed to other users or the user who created it may request that it be sent to another user or group. The quest application 18 may also present group quests, as discussed in more detail with reference to FIG. 4.

The manner in which the quests are presented to the user within the quest application 18 may occur in several ways. There may be a default setting where the quest application 18 selects and presents a quest for the user periodically, such as once a day. This period may also be selected by the user to be more or less frequent than the default setting. A quest may also be presented to the user on demand, whenever the user feels like it. A user may also browse through quests that the quest application 18 has identified as appropriate for her, and select quests from that presented list.

The fourth step is informing the user of the quest criteria 108. Quests are an activity or activities that require at least one milestone, and the milestone is measurable by at least one criteria. When the quest application 18 provides the user with a quest 106, in whatever manner that step may be performed, it must also provide the user with sufficient information to perform that quest. Some quests will be fairly straight forward, such as getting to the top of a particular mountain in a certain amount of time. This quest only has a single activity of climbing the mountain and a single milestone of reaching the top of the mountain in a certain amount of time. The criteria necessary to verify this milestone, however, is threefold. The user must provide a time stamp of when she begins the quest and a time stamp when she completes the quest to ensure she has achieved the timing piece of the criteria. She must also provide location information, provided through GPS capabilities of her user device 24, to prove that she was, in fact, on the top of the mountain when she provided the ending time stamp. Criteria that are simultaneous in nature, such as the last two criteria of the ending time stamp and GPS/location stamp may be provided through a single command in the quest application 18.

This brings us to the fifth step of receiving validation input 110. Each of the pieces of evidence needed to verify that the user completed the quests—the initial time stamp, the final time stamp, and the GPS/location stamp at the top of the mountain—are provided through the quest application 18. For most quests, this final GPS/location stamp will be compared against the user's home base. The quest application 18 will have a user interface that allows the user to, for example, press an area to start a time, thus providing an initial time stamp, and press an area to stop a time, thus providing an ending time stamp. This timekeeping function may be included as a part of the quest application 18, or it may be the timekeeping function of the user mobile device 24 being accessed through the quest application 18. The user interface will also provide an indicator to detect the location of the user device 24 at any given time. This will provide the GPS/location stamp. Again, the GPS capabilities may be inherent in the quest application 18 or may be borrowed from the user device 24 on which the user has downloaded the quest application 18.

A more complicated quest may include several activities, several milestones, and several criteria for achieving the milestone. The quest may be to perform a triathlon sprint and have a beer at the end. The activities would be swimming, biking, running, and having a beer. The first milestone would be completing the ⅓ mile swim. The second milestone would be completing the 15 mile bike ride. The third milestone would be completing the 5K run. The final milestone would be having a celebratory beer. The criteria for these milestones would include a GPS/location stamp before and after the swim, to show that the user is on a body of water. If the swim is a loop or up-and-back course, a time stamp before and after may also be required because the location stamp will be the same before and after the swim. There would also be a GPS/location stamp and/or time stamp after the biking portion. There would also be a GPS/location stamp and/or time stamp after the running portion. If the quest must be completed in a certain amount of time, then the time stamps will be criteria even if the different sections of the triathlon are not loops, i.e. even if GPS/location stamps are sufficient to validate that the user has completed those sections. Finally, the user would need to provide a picture of the beer or empty beer container after having completed the triathlon. In order to affect the fifth step 110 for this more complicated quest, therefore, the user must enter several GPS/location and/or time stamps, as well as a photograph of the beer at the end. The photograph may be taken directly through the quest application 18 or through the user mobile device 24 and then uploaded to the quest application 18. As discussed above, the ability to take photographs may be inherent in the quest application 18, but likely borrows on the existing camera capabilities of the user device 24 on which the quest application 18 is downloaded. The user interface may be customized for each quest. For this triathlon quest, for example, the user interface may guide the user through the milestones, by having the mechanism to validate each of them listed in order: the initial time and location stamp; the time and location stamp between the swim and the bike; the time and location stamp between the bike and the run; the time and location stamp upon completing the run; and the photograph of the beer. An example of this user interface is displayed in FIG. 3.

The step of receiving validation input 110 may be performed in several ways. As described above, it may be performed by receiving a time stamp 114, receiving GPS/location information 116; or receiving a photograph 118. It may also be performed by receiving input from other technology/an external device 120. Many other types of technology or external devices from the mobile device 24 may be linked with the quest application 18 so as to provide validation input thereto. Common fitness monitors include pedometers and heart rate monitors. These may be included in a user device 24 on which the quest application 18 is downloaded, or may be separate devices that may be linked to the user device through wireless or other communication. Pedometers and heart rate monitors might be used, respectively, for a quest that is to walk 10,000 steps for 7 days in a row, or to run 3 miles without letting your heart rate go into the anaerobic zone. Other quests might include criterion that requires other monitors or devices. A quest for a diabetic might be to have a blood sugar reading of 180 mg/dL or less 2 hours after a meal. This quest would require information from a blood glucose monitor. Another quest may be to practice your handwriting and have criteria that the user's pen strokes stay within certain lines. This quest might require the user to use a digital pen and validation of its completion would require information from the digital pen. One of ordinary skill in the art will recognize that there are many devices and technologies that may be paired with the quest application 18 so as to provide validation input for various quests. Those technologies and devices mentioned above are merely exemplary. It is noted, however, that the validation of quests by third party monitoring applications may also be accomplished by taking a screen capture photograph of the display of a third party application running on the player's smart phone, or by photographing the native display of the third party application running on the external monitoring device and uploading this to the quest device. This method has certain advantages, such as allowing any monitoring device to be used, the elimination of frequent updating and bug fixing of application interfaces, and the quest application provider's costs associated therewith.

The final step is determining that the validation input matches the criteria 112. If the criteria involves time limits, then performing step 112 will require checking the time stamps reflect times within these limits. If the criteria requires that the user be at or near a certain place upon completion of the quest, then performing step 112 will be verifying that the GPS/location stamp is at or near that place. If the criteria requires photographic evidence, then performing step 112 will be using scanning and recognition software to recognize an object in the submitted photo that provides the necessary verification. In some cases, the comparison may be made by a person, but it is preferred that the comparison be performed by server 12. If all comparisons between the required criteria and the validation input match, then the quest application 18 may verify that the user completed the quest or milestone.

Now referring to FIG. 4, a block diagram showing additional functions of the quest application 18 are shown. These include providing group options 122; providing notifications 124; providing recognition 126; and providing invitation options 128. The step of providing group options 122 entails providing the user with the option to join a group and/or participate in group quests. The quest application 18 may identify users whose information matches a group's criteria. For our 36 year old runner the quest application 18 may identify groups, for examples, whose respective criterion are women in their 30s or people interested in running. These groups may be actively presented by the quest application 18 to the user whenever sufficient information is provided by the user so that she is matched with a group. It may also be passively presented to the user by allowing the user to browse through groups for which she could be a member. In addition, users may create groups by inputting the group criteria into the quest application 18. Once a user is a member of a group, she may participate in group quests for that group.

The step of providing notifications 124 entails providing the user with notifications. These notifications may be provided only when the user is using the quest application 18, or they may be provided to the user through other communication, such as text message or email, if the user has provided sufficient contact information and permissions for such communication. The user may also dictate when and how notifications are provided, such as only through email; only once per day; or as soon as a notification is ripe. Notifications may be, for examples, that a new group is available for the user to join; that the user has been expressly invited to join a group; that certain milestones within a group quest have been achieved; that the user has received a bonus or voucher; that a new quest is available for the user; encouraging notes while a user is participating in a quest; reminders about criteria for quests; etc. One of ordinary skill in the art will recognize that this list is merely exemplary and that the step of providing notifications may be used for any of a wide number of messages to the user.

The step of providing recognition 126 entails providing the user with some sort of recognition for her participation in quests. The recognition may be badges for completed quests. It may be points for milestones or quests completed. It may be bonuses for a completed group quest or a particularly well performed quest, i.e. if the user performs beyond the necessary criteria. It may be recognition on a leaderboard, such as who has the most points within a group. It may be vouchers for use within the quest application 18 or in real world venues. The vouchers may be directly bestowed upon the user or a user may trade in points for vouchers. These are but a few examples of recognition from the quest application 18 and one or ordinary skill in the art will recognize that many similar types of recognition may also be used.

The step of providing invitation options 128 allows a user to invite other people to do things within the quest application 18. A user may invite a third party to become a user by beginning to use the quest application 18. A user may also invite another user or a third party to join a group. This may be especially applicable if the user has created a group quest and has a certain number of friends with whom he wishes to participate in the group quest.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A method for monitoring a progress of a quest using a mobile device, said method comprising the steps of:
providing a quest application to a user for installation on the mobile device;
receiving through the quest application personal information about the user, including at least a home base of the user;
providing the user with the quest through the quest application, wherein the quest is at least one activity and has at least one milestone and each milestone has at least one criteria for completion in addition to the at least one activity;
informing the user of the at least one criteria for the at least one milestone through the mobile device;
receiving input through the mobile device that the at least one criteria has been met; and
determining that the provided input provides evidence that the at least one criteria has been met.

2. The method as claimed in claim 1, wherein:
the at least one criteria for the at least one milestone is a time by which the quest must be completed; and
said step of receiving input through the mobile device comprises receiving a time indication from the user through the quest application.

3. The method as claimed in claim 1, wherein;
the at least one criteria for the at least one milestone is a location at which the user must be present when the milestone is completed; and
said step of receiving input through the mobile device comprises receiving a location of the mobile device from the user through the quest application.

4. The method as claimed in claim 3, wherein said step of determining that the provided input provides evidence that the at least one criteria has been met comprises comparing the location of the mobile device as received through the quest application with the user's home base.

5. The method as claimed in claim 1, wherein:
the at least one criteria for the at least one milestone is a photograph illustrating at least one object; and
said step of receiving input through the mobile device comprises receiving a photograph taken on the mobile device from the user through the quest application.

6. The method as claimed in claim 1, wherein:
the at least one criteria for the at least one milestone is a time by which the quest must be completed, a location at which the user must be present when the milestone is completed, and a photograph illustrating at least one object; and
said step of receiving input through the mobile device comprises:
receiving a time indication from the user through the quest application;
receiving a location of the mobile device from the user through the quest application; and
receiving a photograph taken on the mobile device from the user through the quest application.

7. The method as claimed in claim 1, wherein:
the at least one criteria for the at least one milestone is a time by which the quest must be completed and a location at which the user must be present when the milestone is completed; and
said step of receiving input through the mobile device comprises:
receiving a time indication from the user through the quest application; and
receiving a location of the mobile device from the user through the quest application.

8. The method as claimed in claim 1, wherein:
the at least one criteria for the at least one milestone is a time by which the quest must be completed and a photograph illustrating at least one object; and
said step of receiving input through the mobile device comprises:
receiving a time indication from the user through the quest application; and
receiving a photograph taken on the mobile device from the user through the quest application.

9. The method as claimed in claim 1, wherein:
the at least one criteria for the at least one milestone is a location at which the user must be present when the milestone is completed, and a photograph illustrating at least one object; and
said step of receiving input through the mobile device comprises:
receiving a location of the mobile device from the user through the quest application; and
receiving a photograph taken on the mobile device from the user through the quest application.

10. The method as claimed in claim 1, wherein:
at least one of the at least one criteria for the at least one milestone is measurable on an external device;
said method further comprises a step of linking the external device to the quest application;
said method further comprises a step of receiving information from the external device; and
said step of receiving input through the mobile device that the at least one criteria has been met comprises receiving information from the external device.

11. The method as claimed in claim 1, wherein:
at least one of the at least one criteria for the at least one milestone is measurable by a third party application;
wherein said method further comprises the steps of:
photographing a display of said third party application to the quest application;
receiving a photograph from the user through the quest application, and
wherein said step of receiving input through the mobile device that the at least one criteria has been met comprises receiving said photograph.

12. The method as claimed in claim 1, said method further comprises the steps of:
providing through the quest application an option for a user to join a group; and
receiving a request from a user to join the group.

13. The method as claimed in claim 12, wherein:
the quest is at least one activity that must be completed with participation of at least one other user in the group;
the at least one criteria for the at least one milestone is receiving verification from another user in the group that the user has completed the at least one milestone; and
receiving verification from the other user in the group that the user has completed the at least one milestone.

14. The method as claimed in claim 12:
wherein the quest is at least one activity that must be completed with participation of at least one other user in the group; and
further comprising the step of providing participating users in the group with notifications of achieved milestones by other participating users in the group.

15. The method as claimed in claim 1, further comprising the steps of:
recording and storing the user's completed quests and milestones of quests; and
providing the user with points based on the user's completed quests and milestones.

16. The method as claimed in claim 15, further comprising the step of providing the user with vouchers based on the user's earned points, wherein the vouchers are exchangeable for items.

17. The method as claimed in claim 15, further comprising:
providing through the quest application an option for a user to a join a group;
receiving a request from a user to join the group;
providing a leaderboard visible to members of the group through the quest application, wherein the leaderboard ranks the users in the group based on the points of the users' completed quests and milestones.

18. The method as claimed in claim 15, wherein:
the quest has at least two milestones;
each milestone earns points for the user; and
a completion of all milestones to complete the quest earns bonus points for each user in the group.

19. The method as claimed in claim 1, further comprising the steps of providing the user with the option to invite a third party to become a user of the quest application;
receiving a request from the user to invite a third party to become a user of the quest application;
sending an invitation to a third party to become a user of the quest application;
receiving a request from a third party to become a user of the quest application.

20. The method as claimed in claim 1, further comprising the steps of:
providing the user with the option to invite another user to join a group;
sending the other user an invitation to the group; and
receiving an acceptance from the other user to join the group.
